(19) United States
(12) Patent Application Publication
(10) Pub. No.: US 2025/0332599 A1
(43) Pub. Date: Oct. 30, 2025

(54) MERCAPTIDE MICROEMULSIONS COLLECTORS FOR MINERAL FLOTATION

(71) Applicant: Arkema Inc., King of Prussia, PA (US)

(72) Inventors: Carlos F. BUITRAGO, King of Prussia, PA (US); Andrew POLLI, King of Prussia, PA (US)

(21) Appl. No.: 18/879,953

(22) PCT Filed: Jun. 22, 2023
(86) PCT No.: PCT/US2023/025912

§ 371 Date: Dec. 30, 2024

Related U.S. Application Data
(60) Provisional application No. 63/357,017, filed on Jun. 30, 2022.

(51) Int. Cl. B03D 1/012; B03D 1/008

(52) U.S. Cl. CPC B03D 1/012; B03D 1/008; B03D 2201/02; B03D 2203/025

(57) ABSTRACT

The present invention provides methods and composition for improving a froth flotation process for the removal of mineral values from aqueous solutions. The method uses mercaptide microemulsions to improve the separation effectiveness of a collector. The present invention provides a method of enhancing the performance of a collector in a froth flotation separation of mineral ore in a medium, the method comprising the steps of: forming a slurry by blending a collector microemulsion, the mineral ore in a medium, and optionally other additives, —and removing concentrate from the ore by sparging the slurry; wherein the collector microemulsion comprises a continuous phase which is an aqueous carrier fluid and a dispersed phase comprises a mercaptide.

### FIELD OF THE INVENTION

The invention relates to novel mercaptide microemulsion collectors for concentrating valuable minerals from ore bodies.

### BACKGROUND OF THE INVENTION

The present invention relates generally to mineral recovery by froth flotation operations. In one aspect, the invention relates to ore flotation processes, such as, for example, those processes involving recovery of metals such as Cu, Mo, Pb, Co, Zn, Ni, Au, Ag, Pt, Pd, and/or Rh using novel mercaptide microemulsions.

Froth flotation separation can be used to separate solids from solids (such as the constituents of mine ore) or liquids from other liquids or from solids (such as the separation of bitumen from oil sands). When used on solids, froth flotation also often includes having the solids comminuted (ground up by such techniques as dry-grinding, wet-grinding, and the like). After the solids have been comminuted they are more readily dispersed in an aqueous slurry and the small solid hydrophobic particles can more readily adhere to sparge bubbles.

Flotation processes are used for recovering and concentrating valuable minerals from ores. In froth flotation processes, the ore is crushed and wet ground to obtain a pulp. The pulp is then aerated to produce a froth at the surface. The minerals which adhere to the bubbles or froth are skimmed or otherwise removed and the mineral-bearing froth is collected and further processed to recover the desired minerals. Other valuable minerals can be recovered from the tail product which is separated from the mineral-bearing froth during the flotation process.

There are a number of additives that can be added to increase the efficiency of a froth flotation separation. Collectors are additives which adhere to the surface of concentrate particles and enhance their overall hydrophobicity. Gas bubbles then preferentially adhere to the hydrophobized concentrate and they are then more readily removed from the slurry than are other constituents, which are less hydrophobic or are hydrophilic. As a result, the collector efficiently pulls particular constituents out of the slurry while the remaining tailings which are not modified by the collector, remain in the slurry. Typical mineral flotation collectors include xanthates, amines, alkyl sulfates, hydrocarbons, sulfonates, dithiocarbamates, dithiophosphates, and thiols. Other additives can include activators, frothers and/or depressants, which enhance the selectivity of the flotation step and facilitate the removal of the concentrate from the slurry.

The performance of collectors can be enhanced by the use of activators. Activators are a wide variety of chemicals which in one or more ways enhance the effectiveness of collectors. One way activators work is by enhancing the dispersion of the collector within the slurry. Another way is by increasing the adhesive force between the concentrate and the bubbles. A third way is by increasing the selectivity of what adheres to the bubbles.

Frothing agents or frothers are chemicals added to the process which have the ability to change the surface tension of a liquid such that the properties of the sparging bubbles are modified. Frothers may act to stabilize air bubbles so that they will remain well-dispersed in slurry, and will form a stable froth layer that can be removed before the bubbles burst. Ideally, the frother should not enhance the flotation of unwanted material and the froth should have the tendency to break down when removed from the flotation apparatus.

Collectors are typically added before frothers and they both need to be such that they do not chemically interfere with each other. Commonly used frothers include pine oil, aliphatic alcohols such as MIBC (methyl isobutyl carbinol), polyglycols, polyglycol ethers, polypropylene glycol ethers, polyoxyparaffins, cresylic acid (xylenol), commercially available alcohol blends such as those produced from the production of 2-ethylhexanol and any combination thereof.

Collectors adhere to the surfaces of concentrate particles. Their effectiveness is dependent on the nature of the interactions that occur between the collectors and the concentrate particles. Unfortunately, contradictory principles of chemistry are at work in froth flotation separation which forces difficulties on such interactions. Because froth flotation separation relies on separation between more hydrophobic and more hydrophilic particles, the slurry medium often includes water. Because, however, many commonly used collectors are themselves hydrophobic, they do not disperse well in water which makes their interactions with concentrate particles difficult or less than optimal.

While the art of ore flotation has reached a significant degree of sophistication, it is a continuing goal in the ore recovery industry to increase the productivity of ore flotation processes and, above all, to provide specific processes which are selective to one ore or to one metal over other ores or other metals, respectively, which are present in the materials being treated in such processes. Accordingly, the development of alternative collector compositions to improve the recovery of minerals via floatation

Heavy mercaptans have unique chemical properties that make them especially useful in applications such as mineral recovery, metal protection, surface modification, polymer functionalization, among others. However, heavy mercaptans also exhibit a strong odor and immiscibility with water, which limit their use in many applications.

### SUMMARY OF THE INVENTION

In accordance with this invention, it has been found that the recovery of minerals bearing metals such as Cu, Mo, Pb, Co, Zn, Ni, Au, Ag, Pt, Pd, and/or Rh can be enhanced via use of a mercaptide microemulsions as a collector in forth floatation processes. An object of the present invention is to reduce the perceived odor of heavy mercaptans (liquids) by the use of mercaptides in which the mercaptan thiol group has been transformed into an ionic thiolate. The heavy mercaptide salts (solids) also attain an improved compatibility with water, allowing for the preparation of water-based formulations with unique microstructures (microemulsions). The water-based mercaptide microemulsions exhibit a lower perceived odor than mercaptans, and the activity improves due to the increased interfacial area typical of microstructures.

### BRIEF DESCRIPTION OF THE FIGURES

FIG. 1 is graph of mineral recovery as a function of pH for the flotation of pyrite and chalcopyrite using a sodium mercaptide microemulsion (sample 5) in a Hallimond tube.

FIGS. 2 and 3 are graphs of copper and molybdenum recovery/grade, respectively, from a Cu—Mo ore for a microemulsion of sodium mercaptide, as compared to N-dodecyl mercaptan and sodium dicresyl dithiophosphate.

FIG. 4 is a graph of recovery from a gold ore using sodium mercaptide, as compared to sodium dicresyl dithiophosphate, as a collector in tandem with potassium amyl xanthate.

### DETAILED DESCRIPTION OF CERTAIN EMBODIMENTS OF THE INVENTION

The following definitions are provided to determine how terms used in this application, and in particular how the claims, are to be construed. The organization of the definitions is for convenience only and is not intended to limit any of the definitions to any particular category.

“Collector” means a molecule or a composition of matter containing a selection of molecules that selectively adhere to a particular constituent of the ore and facilitate the adhesion of the particular constituent to the micro-bubbles that result from the sparging of the ore slurry.

“Comminuted” means powdered, pulverized, ground, or otherwise rendered into fine solid particles.

“Concentrate” means the portion of the ore which is separated from the slurry by flotation and collected within the froth layer.

“Ore” means a composition of matter containing a mixture of a more wanted material, the beneficiary and a less wanted material, the gangue.

“Frother” or “Frothing Agent” means a composition of matter that enhances the formation of the micro-bubbles and/or preserves the formed micro-bubbles bearing the hydrophobic fraction that result from the sparging of slurry.

“Microemulsion” means a dispersion comprising a continuous phase material, substantially uniformly dispersed within which are droplets of a dispersed phase material, the droplets are sized in the range of approximately from 1 to 100 nm, usually 10 to 50 nm.

“Slurry” means a mixture comprising a liquid medium within which ore particles (finely divided solids) are dispersed or suspended, when a slurry is sparged, the tailings remain in the slurry and at least some of the concentrate adheres to the sparge bubbles and rise up out of the slurry into a froth layer above the slurry. The liquid medium may be entirely water or a partially aqueous system.

In at least one embodiment a froth flotation separation process is enhanced by the addition to the slurry of an inventive composition. The composition comprises a mercaptide collector, a solvent (such as water and/or another solvent), optionally one or more surfactants (optionally with one or more co-surfactants) and optionally dispersants which is in the form of a microemulsion.

The composition not only enhances the recovery of the concentrate but also increases the selectivity of the concentrate, increasing the proportion of valuables while reducing the proportion of gangue in the concentrate. While effective in many forms of beneficiation the invention is particularly effective in flotation of sulfide minerals containing metals such as Cu, Mo, Pb, Co, Zn, Ni, Au, Ag, Pt, Pd and/or Rh. The slurry treated by the mercaptide microemulsion of the present invention can comprise an ore containing one or more items selected from the group consisting of copper, gold, silver, iron, lead, nickel, cobalt, platinum, zinc, coal, barite, calamine, dolomite, feldspar, fluorite, heavy metal oxides, talc, potash, phosphate, iron, graphite, kaolin clay, bauxite, pyrite, mica, quartz, sulfide ore, complex sulfide ore, non-sulfide ore, silica and any combination thereof.

A microemulsion is a dispersion comprising a continuous phase material, dispersed within which are droplets of a dispersed phase material. The droplets are sized in the range of approximately from about 1 to about 100 nm, preferably about 10 to about 50 nm. Because of the extremely small size of the droplets, a microemulsion is optically clear, isotropic and thermodynamically stable. In at least one embodiment the continuous phase material comprises water. In at least one embodiment the dispersed phase material and/or the continuous phase material comprise one or more hydrophobic materials. In at least one embodiment, the dispersed phase material and/or the continuous phase material comprise amphiphilic and/or ionic materials.

Mercaptans (also known as thiols) may be in the liquid form at standard environmental temperature and pressure comprising a hydrocarbon chain composed of eight to twelve carbon atoms. Such liquid mercaptans are immiscible with water. In addition, these liquids are volatile enough to raise concerns associated to noxious odor, which limits the use of these substances in many applications, particularly those carried out in open vessels. In the present invention, liquid thiols which have been treated with strong organic or inorganic base(s) to produce mercaptides (ionic salts of mercaptans) are employed. In one embodiment, the mercaptides are produced as pure products, solid powders which have improved compatibility with water and do not present the odor concerns associated with thiol volatility which are used to form mercaptide microemulsions. The mercaptide microemulsions can comprise components such as water, alcohols, hydrocarbons, surfactants and/or dispersing agents.

The alcohol can be selected from the following group, including isomers thereof: ethanol, propanol, butanol, pentanol, hexanol, heptanol, octanol, terpene alcohols, cresylic acid and any combination thereof.

The hydrocarbon can be selected from the group pentane, hexane, heptane, octane, decane, dodecane, propylene tetramer, kerosene, diesel fuel, biodiesel (methylated fatty acids) and any combination thereof.

The surfactant can be selected from the group ethoxylated mercaptans, alkylphenol ethoxylates, aklylbenzene sulfonates, poloxamers (e.g., Pluronic™), polysorbates and any combination thereof.

The dispersing agent can be selected from the group polyethylene glycol, polypropylene glycol, polyglycol ethers and/or other polyols.

The mercaptide is used in the form of a mercaptide microemulsions. The mercaptide salts derived from mercaptans may also be provided as a solid after reaction with the base only. The solid mercaptides salts can be used to make the mercaptide microemulsions for use in the present invention by mixing them with the described components prior to use.

It was discovered that solids crash out of the mercaptide microemulsions liquid during extensive manipulation. By subjecting duplicate samples to different post-reaction treatments, it was discovered that mercaptides in the microemulsions can oxidize to disulfides in the presence of oxygen. Thus, for stability it is desirable to minimize or avoid oxidation of mercaptide ions to disulfides.

Heavy mercaptans are thiols (—SH) with hydrocarbon chains between 4 and 18 carbon atoms, typically from about 8 to 15 carbon atoms. The hydrocarbon chains can be straight, branched or cyclical. The mercaptides, which may comprise mercaptides, dimercaptides or polymercaptides, may originate from mercaptans (molecules containing one thiol group only) or from dithiols or polythiols (two or more thiol groups per molecule). Primary mercaptans, secondary or tertiary mercaptans having 8-15 carbon atoms may also be used. Exemplary dithiols and polythiols, respectively include 1,8-dimercaptan-3,6-dioxaoctane and pentaerythritol tetra(3-mercaptopropinate). When these molecules are subjected to pH values greater than or equal to about 11, the conjugate base mercaptides form, transforming the —SH group into the ionic S-M+, where M+ is an organic or inorganic cation from a strong base. For example, alkali metal or alkaline earth metal hydroxide bases such as sodium hydroxide, potassium hydroxide, rubidium hydroxide, magnesium hydroxide, calcium hydroxide, lithium hydroxide, barium hydroxide and magnesium hydroxide, or organic bases such as ammonium hydroxide, tetramethylguanidine (which forms the guanidinium cation), guanidine or tetramethylammonium hydroxide will form the conjugate mercaptide when contacted with a mercaptan.

Heavy mercaptide salts are free flowing solids, typically in their pure form or with only minor and/or reaction product impurities.

The microemulsion formulations can comprise the mercaptides, water, and optionally alcohols, hydrocarbons, glycols, polyglycols, surfactants, and/or excess amounts of mercaptan and base from the mercaptide conversion.

Certain mercaptide powders alone have moderate affinity for water, giving rise to homogeneous liquid products without the need for other components. For example, a mercaptide salt of N-dodecyl mercaptan can form a homogeneous mixture in water in concentrations up to about 2 wt % (from 0.00001 to about 2 wt %). With the addition of the liquid components, microemulsions form that may contain as much as 60 wt % mercaptide. A preferred range is between about 0.01 and about 40 wt % mercaptide. Water content can range from about 20 to about 98.0 wt % (as diluent of pure mercaptide powders) preferably from about 40 to about 98 wt % for multicomponent microemulsions. Alcohols can be added between about 2 and about 30 wt %. A preferred range for the alcohols is between about 5 and about 20 wt %. Surfactants may be added between 0 and about 10 wt %. Dispersing agents may be added between 0 and about 20 wt %, more preferably between 5 and 15 wt %. Formation of mercaptides may be accomplished by reacting thiols with equivalent moles of base, although as much as about 1 to about 5 wt % excess base can be used.

During application in froth flotation, the mercaptide compositions (including powder form or microemulsion) can be used along with frother and with other collectors that aid in the power and selectivity of the mercaptide collectors. Examples of frothers useful in this invention include any of those known in the art, including but not limited to C5-C8 alcohols, pine oils, cresols, C1-C4 alkyl ethers of polypropylene glycols, dihydroxylates of polypropylene glycols, glycols, fatty acids, soaps, alkaryl sulfonates, and combinations thereof. Additional collectors that may be used in combination with the mercaptide microemulsion of the present invention can include, for example, those based on xanthates, dithiophosphates, monothiophosphates, mercaptobenzothiazoles, dithiocarbamates, trithiocarbonates, thionocarbamates, thioureas, guanadines or combinations thereof.

### Additional Embodiments

Additionally or alternatively, the present invention can include one, some, or all or the following embodiments.

Embodiment 1. A method of enhancing the performance of a collector in a froth flotation separation of mineral ore in a medium, the method comprising the steps of: forming a slurry by blending a collector microemulsion, the mineral ore in a medium, and optionally other additives, and removing concentrate from the ore by sparging the slurry; wherein the collector microemulsion comprises a continuous phase which is an aqueous carrier fluid and a dispersed phase comprises a mercaptide.

Embodiment 2. The method of embodiment 1 in which the continuous phase is water.

Embodiment 3. The method of embodiment 1 or embodiment 2 in which the mercaptan is selected from the group consisting of thiols, dithiols, polythiols and any combination thereof.

Embodiment 4. The method of any of the previous embodiments wherein the mercaptide selected from the group consisting of straight chain, branched chain or cyclical primary C8 to C15 mercaptide; straight chain, branched chain or cyclical secondary C8 to C15 mercaptide; straight chain, branched chain or cyclical tertiary C8 to C15 mercaptide and any combination thereof.

Embodiment 5. The method of any of the previous embodiments in which the microemulsion further comprises at least one item selected from the group consisting of surfactants, alcohols, hydrocarbons, dispersing agents and any combination thereof.

Embodiment 6. The method of any of the previous embodiments in which the slurry comprises an ore containing one or more items selected from the group consisting of copper, gold, silver, iron, lead, nickel, cobalt, platinum, zinc, coal, barite, calamine, dolomite, feldspar, fluorite, heavy metal oxides, talc, potash, phosphate, iron, graphite, kaolin clay, bauxite, pyrite, mica, quartz, sulfide ore, complex sulfide ore, non-sulfide ore, silica and any combination thereof.

Embodiment 7. The method of any of the previous embodiments in which the microemulsion further comprises a surfactant along with at least one co-surfactant.

Embodiment 8. The method of any of embodiments 5-7, wherein the surfactant and/or co-surfactant is selected from the group consisting of ethoxylated mercaptans, alkylphenol ethoxylates, aklylbenzene sulfonates, poloxamers, polysorbates and any combination thereof.

Embodiment 9. The method of any of embodiments 5-8, wherein the alcohol is selected from the group consisting of ethanol, propanol, butanol, pentanol, hexanol, heptanol, octanol, terpene alcohols, cresylic acid and any isomers and combination thereof.

Embodiment 10. The method of any of embodiments 5-8, wherein the hydrocarbon is selected from the group consisting of pentane, hexane, heptane, octane, decane, dodecane, propylene tetramer, kerosene, diesel fuel, biodiesel (methylated fatty acids) and any combination thereof and any combination thereof.

Embodiment 11. The method of any of embodiments 5-8, wherein the dispersing agent is selected from the group consisting of polyethylene glycol, polypropylene glycol, polyglycol ethers, polyols and any combination thereof.

Embodiment 12. The method in any of the previous embodiments, wherein forming the slurry further includes blending frothers selected from the group consisting of C5-C8 alcohols, pine oils, cresols, C1-C4 alkyl ethers of polypropylene glycols, dihydroxylates of polypropylene glycols, glycols, fatty acids, soaps, alkaryl sulfonates and combinations thereof.

Embodiment 13. The method in any of the previous embodiments, where forming the slurry further includes blending collectors selected from the group consisting of xanthates, dithiophosphates, monothiophosphates, mercaptobenzothiazoles, dithiocarbamates, trithiocarbonates, thionocarbamates, thioureas, guanadines and combinations thereof.

### Example 1

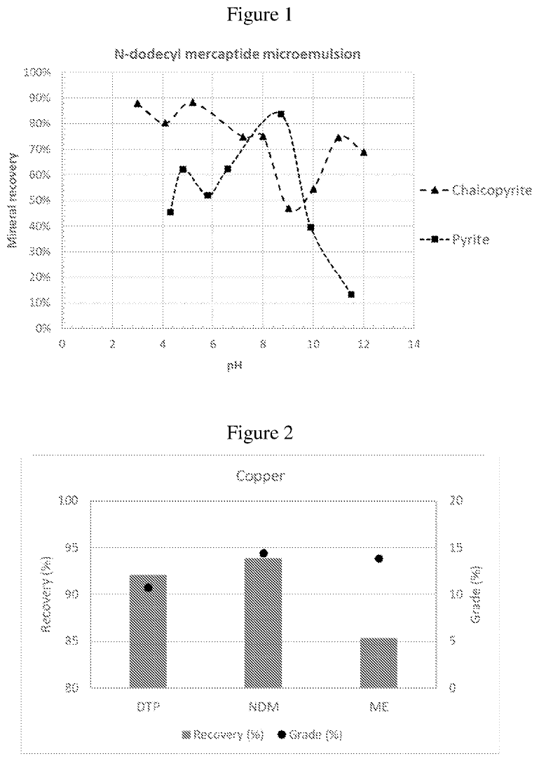

Application of mercaptide microemulsions as a collector for froth flotation was evaluated by floating 2 grams of pure mineral in a ˜200-ml Hallimond tube. Dosages of ˜5 microliters of the mercaptide microemulsions were added at pH values spanning pH ˜4 through pH ˜12. At each pH value, flotation was carried out for ˜5 minutes using nitrogen gas at a flow rate of ˜40 ml/min. Both, chalcopyrite (CuFeS2) and pyrite (FeS2) were floated successfully, although improved selectivity was found for chalcopyrite over the less valuable pyrite at pH values above 10. Results are summarized in FIG. 1.

### Example 2

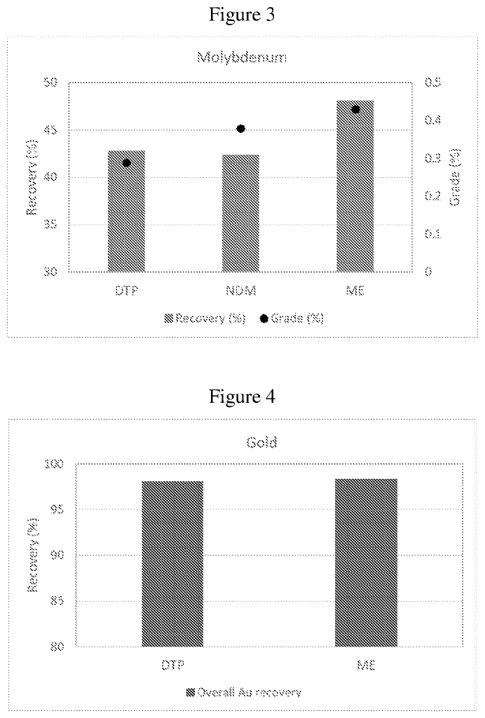

Another example of the application of mercaptide microemulsion as collector was evaluated via rougher flotation of a Cu—Mo ore. Results are summarized in FIGS. 2 and 3. In this test, ˜500 grams of ore were added to a ˜2.5 L Denver flotation cell, which was dosed with the collectors, frother, and kept at pH ˜10 for about a 2-minute conditioning time. The collection time was ˜5 minutes using air as the frothing medium. In this test, a mercaptide microemulsion (ME) dosed at ˜120 g/ton (˜24 g/ton of active ingredient sodium dodecyl mercaptide) was compared to N-dodecyl mercaptan (NDM) and sodium dicresyl dithiophosphate (DTP), both dosed at ˜54 g/ton. Although comparatively lower Cu recovery was achieved for ME, it was unexpectedly high at ˜85%, given that the active ingredient is less than half of the other collectors. In addition, the Cu grade in the concentrate was around 14%, similar to NDM but slightly higher than the ˜12% of DTP. Improved recovery and grade were achieved for Mo in comparison to NDM and DTP. In this case, ME achieved ˜48% Mo recovery and ˜0.43% grade.

### Example 3

Similar to Example 2, the mercaptide microemulsion (ME) was compared to sodium dicresyl dithiophosphate (DTP) as collectors for an Au ore. The flotation parameters were the same, except for collection time, which was about 10 minutes. Besides ME and DTP at dosages of ˜48 g/ton, potassium amyl xanthate (PAX) was dosed at ˜24 g/ton in both cases. It is worth noting that the total amount of active ingredient in ME (sodium dodecyl mercaptide) was ˜10 g/ton. Overall Au recovery using both collectors was ˜98%, proving once again the effectiveness of the invention in precious and base metal processing. Graphic comparison for Example 3 in FIG. 4.

The invention claimed is:

1. A method of enhancing the performance of a collector in a froth flotation separation of mineral ore in a medium, the method comprising the steps of:
forming a slurry by blending a collector microemulsion, the mineral ore in a medium, and optionally other additives, and
removing concentrate from the ore by sparging the slurry;
wherein the collector microemulsion comprises a continuous phase which is an aqueous carrier fluid and a dispersed phase comprises a mercaptide.

2. The method of claim 1 in which the continuous phase is water.

3. The method of claim 1 in which the mercaptan is selected from the group consisting of thiols, dithiols, polythiols and any combination thereof.

4. The method of claim 1 wherein the mercaptide selected from the group consisting of straight chain, branched chain or cyclical primary C8 to C15 mercaptide; straight chain, branched chain or cyclical secondary C8 to C15 mercaptide; straight chain, branched chain or cyclical tertiary C8 to C15 mercaptide and any combination thereof.

5. The method of claim 1 in which the microemulsion further comprises at least one item selected from the group consisting of surfactants, alcohols, hydrocarbons, dispersing agents and any combination thereof.

6. The method of claim 1 in which the slurry comprises an ore containing one or more items selected from the group consisting of copper, gold, silver, iron, lead, nickel, cobalt, platinum, zinc, coal, barite, calamine, dolomite, feldspar, fluorite, heavy metal oxides, talc, potash, phosphate, iron, graphite, kaolin clay, bauxite, pyrite, mica, quartz, sulfide ore, complex sulfide ore, non-sulfide ore, silica and any combination thereof.

7. The method of claim 1 in which the microemulsion further comprises a surfactant along with at least one co-surfactant.

8. The method of claim 5, wherein the surfactant is selected from the group consisting of ethoxylated mercaptans, alkylphenol ethoxylates, aklylbenzene sulfonates, poloxamers, polysorbates and any combination thereof.

9. The method of claim 5, wherein the alcohol is selected from the group consisting of ethanol, propanol, butanol, pentanol, hexanol, heptanol, octanol, terpene alcohols, cresylic acid and any isomers and combination thereof.

10. The method of claim 5, wherein the hydrocarbon is selected from the group consisting of pentane, hexane, heptane, octane, decane, dodecane, propylene tetramer, kerosene, diesel fuel, biodiesel (methylated fatty acids) and any combination thereof and any combination thereof.

11. The method of claim 5, wherein the dispersing agent is selected from the group consisting of polyethylene glycol, polypropylene glycol, polyglycol ethers, polyols and any combination thereof.

12. The method of claim 1, wherein forming the slurry further includes blending frothers selected from the group consisting of C5-C8 alcohols, pine oils, cresols, C1-C4 alkyl ethers of polypropylene glycols, dihydroxylates of polypropylene glycols, glycols, fatty acids, soaps, alkaryl sulfonates and combinations thereof.

13. The method in claim 1, where forming the slurry further includes blending collectors selected from the group consisting of xanthates, dithiophosphates, monothiophosphates, mercaptobenzothiazoles, dithiocarbamates, trithiocarbonates, thionocarbamates, thioureas, guanadines and combinations thereof.
